(19) United States
(12) Patent Application Publication
(10) Pub. No.: US 2025/0102657 A1
(43) Pub. Date: Mar. 27, 2025

(54) INFORMATION PROCESSING SYSTEM, INFORMATION PROCESSING APPARATUS, AND INFORMATION PROCESSING METHOD

(71) Applicant: SONY GROUP CORPORATION, TOKYO (JP)

(72) Inventor: DAISUKE MATSUO, TOKYO (JP)

(21) Appl. No.: 18/291,258

(22) PCT Filed: Mar. 9, 2022
(86) PCT No.: PCT/JP2022/010256

§ 371 Date: Jan. 23, 2024

(30) Foreign Application Priority Data
Aug. 19, 2021 (JP) 2021-134268

(51) Int. Cl. G01S 13/10; G01S 13/87

(52) U.S. Cl. CPC G01S 13/10; G01S 13/878

(57) ABSTRACT

An information processing system according to an embodiment of the present technology includes a plurality of radar apparatuses, information processing apparatuses, and an output apparatus. The information processing apparatus includes a distance calculator and a processor. The distance calculator is used to calculate a distance to an object, the calculation of the distance being performed using at least one of the plurality of radar apparatuses. The processor causes, when the distance to the object is less than a specified threshold, a process of detecting different reflection points on the object to be performed, the detections of the different reflection points on the object being performed by use of respective radar apparatuses of the plurality of radar apparatuses; and causes, when the distance to the object is greater than or equal to the specified threshold, a process of detecting an in-common reflection point on the object to be performed, the detection of the in-common reflection point on the object being performed by digital radar signals from the respective radar apparatuses of the plurality of radar apparatuses being combined. The output apparatus includes an output section that outputs reflection-point information regarding the reflection point on the basis of the detection processes performed by the processors.

### TECHNICAL FIELD

The present technology relates to an information processing system, an information processing apparatus, and an information processing method that are applicable to, for example, a radar apparatus.

### BACKGROUND ART

Patent Literature 1 discloses a radar apparatus that estimates a partial region on the basis of a position, on a target, at which a reflection point is detected, and on the basis of the intensity of a reception signal obtained by receiving a reflected wave coming from the reflection point, the partial region being a region in which a portion of the target is present; and estimates a region that is occupied by the target, on the basis of at least one estimated partial region. This results in successfully estimating the region occupied by the target (for example, paragraphs to of the specification, and FIG. 6 in Patent Literature 1).

### CITATION LIST

### Patent Literature

Patent Literature 1: Japanese Patent Application Laid-open No. 2020-3336

### DISCLOSURE OF INVENTION

### Technical Problem

There is a need for a technology that makes it possible to detect an object with a high degree of accuracy when a radar apparatus detects the object.

In view of the circumstances described above, it is an object of the present technology to provide an information processing system, an information processing apparatus, and an information processing method that make it possible to detect an object with a high degree of accuracy.

### Solution to Problem

In order to achieve the object described above, an information processing system according to an embodiment of the present technology includes a plurality of radar apparatuses, information processing apparatuses, and an output apparatus.

The information processing apparatus includes a distance calculator and a processor.

The distance calculator is used to calculate a distance to an object, the calculation of the distance being performed using at least one of the plurality of radar apparatuses.

The processor causes, when the distance to the object is less than a specified threshold, a process of detecting different reflection points on the object to be performed, the detections of the different reflection points on the object being performed by use of respective radar apparatuses of the plurality of radar apparatuses; and causes, when the distance to the object is greater than or equal to the specified threshold, a process of detecting an in-common reflection point on the object to be performed, the detection of the in-common reflection point on the object being performed by digital radar signals from the respective radar apparatuses of the plurality of radar apparatuses being combined.

The output apparatus includes an output section that outputs reflection-point information regarding the reflection point on the basis of the detection processes performed by the processors.

In the information processing system, distances from radar apparatuses of a plurality of radar apparatuses to the object are calculated. When the distances to the object are less than a specified threshold, a process of detecting different reflection points on the object by use of the respective radar apparatuses of the plurality of radar apparatuses, is performed. When the distances to the object are greater than or equal to the specified threshold, a process of detecting an in-common reflection point on the object by digital radar signals from the radar apparatuses of the plurality of radar apparatuses being combined to form a large aperture array antenna, is performed. This makes it possible to detect an object with a high degree of accuracy.

The information processing apparatus may include a first estimator that estimates the reflection-point information regarding the different reflection point on the basis of a radar signal related to the object when the distance to the object is less than the specified threshold. In this case, the output apparatus may include a second estimator that estimates the reflection-point information regarding the in-common reflection point on the basis of radar signals related to the object when the distance to the object is greater than or equal to the specified threshold.

The reflection-point information may include at least one of a distance, a speed, or a direction.

The specified threshold may include what is determined on the basis of a positional relationship between the radar apparatuses of the plurality of radar apparatuses arranged.

The information processing apparatus may include a switcher that switches between the process of detecting the different reflection points on the object by use of the respective radar apparatuses of the plurality of radar apparatuses, and the process of detecting the in-common reflection point on the object by the digital radar signals from the respective radar apparatuses of the plurality of radar apparatuses being combined, the detections of the different reflection points on the object being performed on the basis of first estimation results respectively obtained by the pieces of reflection-point information being estimated by the respective first estimators, the detection of the in-common reflection point on the object being performed on the basis of a second estimation result obtained by the reflection-point information being estimated by the second estimator.

When the second estimation result shows that objects of a plurality of objects are detected at different angles, the switcher may switch to the process of detecting the in-common reflection point on the object by the digital radar signals from the respective radar apparatuses of the plurality of radar apparatuses being combined.

When the number of the reflection points detected as the second estimation result is larger than the number of the reflection points detected as the first estimation result, the switcher may switch to the process of detecting the in-common reflection point on the object by the digital radar signals from the respective radar apparatuses of the plurality of radar apparatuses being combined.

When the first estimation result shows that the reflection points are situated close to each other, the switcher may switch between the process of detecting the different reflection points on the object by use of the respective radar apparatuses of the plurality of radar apparatuses, and the process of detecting the in-common reflection point on the object by the digital radar signals from the respective radar apparatuses of the plurality of radar apparatuses being combined, the switching being performed on the basis of distances to the respective reflection points and speeds of the respective reflection points.

When the distance to the object is less than the specified threshold, the processor may output the reflection-point information estimated by the first estimator to the output section through a first network; and when the distance to the object is greater than or equal to the specified threshold, the processor may output the radar signal related to the object to the second estimator through a second network.

An information processing apparatus according to an embodiment of the present technology includes a distance calculator and a processor.

The distance calculator is used to calculate a distance to an object, the calculation of the distance being performed using at least one of a plurality of radar apparatuses.

The processor causes, when the distance to the object is less than a specified threshold, a process of detecting different reflection points on the object to be performed, the detections of the different reflection points on the object being performed by use of respective radar apparatuses of the plurality of radar apparatuses; and causes, when the distance to the object is greater than or equal to the specified threshold, a process of detecting an in-common reflection point on the object to be performed, the detection of the in-common reflection point on the object being performed by digital radar signals from the respective radar apparatuses of the plurality of radar apparatuses being combined.

An information processing method according to an embodiment of the present technology is an information processing method that is performed by a computer system, the information processing method including calculating a distance to an object, the calculation of the distance being performed using at least one of a plurality of radar apparatuses.

When the distance to the object is less than a specified threshold, a process of detecting different reflection points on the object is caused to be performed, the detections of the different reflection points on the object being performed by use of respective radar apparatuses of the plurality of radar apparatuses; and when the distance to the object is greater than or equal to the specified threshold, a process of detecting an in-common reflection point on the object is caused to be performed, the detection of the in-common reflection point on the object being performed by digital radar signals from the respective radar apparatuses of the plurality of radar apparatuses being combined.

### BRIEF DESCRIPTION OF DRAWINGS

FIG. 1 schematically illustrates an overview of an information processing system.

FIG. 2 is a block diagram illustrating an example of a configuration of the information processing system.

FIG. 3 is a block diagram illustrating an example of a configuration of a detection processor.

FIG. 4 is a schematic diagram used to describe a state until a peak is detected from a digital radar signal.

FIG. 5 is a set of graphs of chirp signals upon applying the FCM approach.

FIG. 6 schematically illustrate a short-distance object detection performed using a plurality of radar apparatuses and a long-distance object detection performed using the plurality of radar apparatuses.

FIG. 7 is a flowchart illustrating an operation of the detection processor.

FIG. 8 is a block diagram illustrating an example of a configuration of a vehicle control system that corresponds to an example of an information processing system to which the present technology is applied.

FIG. 9 illustrates an example of regions of sensing performed by, for example, a camera, a radar apparatus, LiDAR, and an ultrasonic sensor of an external recognition sensor illustrated in FIG. 8.

FIG. 10 is a block diagram illustrating an example of a hardware configuration of the detection processor.

### MODE(S) FOR CARRYING OUT THE INVENTION

Embodiments according to the present technology will now be described below with reference to the drawings.

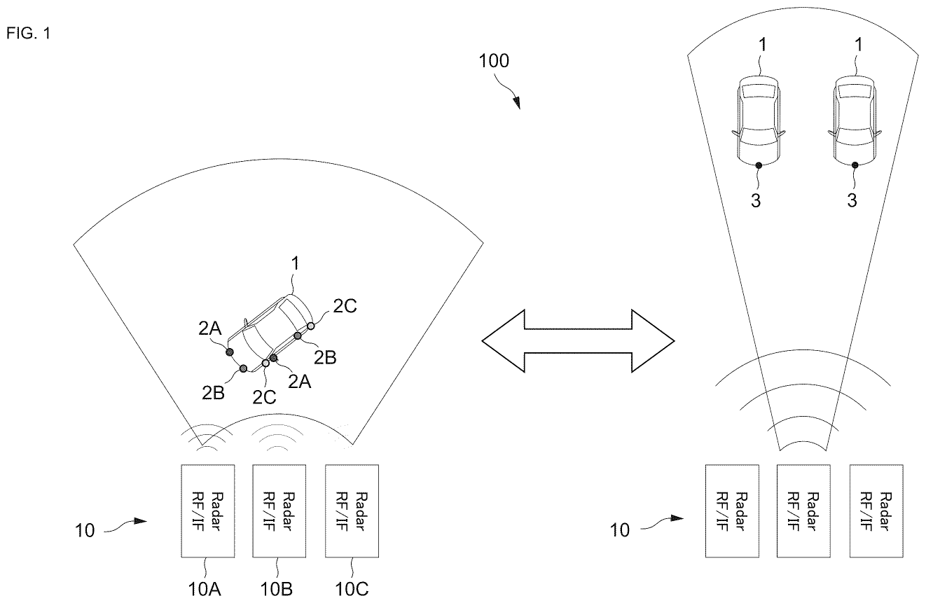

FIG. 1 schematically illustrates an overview of an information processing system according to the present technology.

As illustrated in FIG. 1, an information processing system 100 includes a plurality of radar apparatuses 10. For example, the plurality of radar apparatuses 10 is included in a mobile object such as an automobile, a drone, and an autonomous mobile robot. In other words, the information processing system 100 can be applied to, for example, recognition of an obstacle, generation of a map in a surrounding environment, and pursuit of a mobile object in the surroundings. Without being limited thereto, a plurality of radar apparatuses may be placed at, for example, an intersection to be applied to traffic monitoring for, for example, traffic observation and risk prediction.

The radar apparatuses 10 of a plurality of radar apparatuses 10 each generate a transmission signal to emit the generated transmission signal into a space in the form of a transmission wave. Further, the radar apparatuses 10 of the plurality of radar apparatuses 10 each receive, in the form of a reflected wave, the transmission wave reflected at a reflection point 2 on an object 1. Note that a positional relationship between radar apparatuses of a plurality of radar apparatuses placed, and the number of the radar apparatuses of the plurality of radar apparatuses placed, are not limited.

The information processing system 100 performs switching on a process of detecting the reflection point 2, on the basis of a distance to the object 1. In the present embodiment, when the object 1 is situated at a short distance from the information processing system 100, the radar apparatuses 10 of the plurality of radar apparatuses 10 detect different reflection points on the object 1. For example, in a left portion of FIG. 1, radar apparatuses 10A, 10B, and 10C respectively receive reflected waves reflected at reflection points 2A, 2B, and 2C on the object.

Further, when the object 1 is situated at a long distance from the information processing system 100, digital radar signals from the plurality of radar apparatuses 10 are combined, and the plurality of radar apparatuses 10 serves as a single radar apparatus. Accordingly, a process of detecting a reflection point 3 on the object 1 is performed.

In other words, when the object 1 is situated at a short distance, the radar apparatuses 10 of a plurality of radar apparatuses 10 each perform a detection process and thus a lot of reflection points are detected. This makes it possible to obtain a lot of pieces of reflection-point information regarding reflection points. Further, when the object 1 is situated at a long distance, digital radar signals from the radar apparatuses 10 of a plurality of radar apparatuses 10 are combined to form a large aperture array antenna, and the plurality of radar apparatuses 10 serves as a single radar apparatus to perform a detection process. This makes it possible to obtain reflection-point information with high resolution provided using a large aperture.

The reflection-point information includes a distance to a reflection point, a speed of the reflection point, and a direction of the reflection point. Examples of the reflection-point information may include a distance by which a reflected wave reflected off the object 1 is received by a reception antenna of the radar apparatus, a relative speed of the object 1 relative to a mobile object including the radar apparatus, and an angle at which the object 1 is situated with respect to a direction in which the mobile object including the radar apparatus travels.

Note that a method for combining a plurality of radar apparatuses 10 is not limited, and the combing method may be performed using, for example, a combining aperture obtained by a plurality of radar apparatuses 10 being synchronized with a high degree of accuracy, combining performed by correcting for a phase difference between the radar apparatuses 10 of a plurality of radar apparatuses 10, or combining performed by averaging an array antenna correlation matrix of a plurality of radar apparatuses 10.

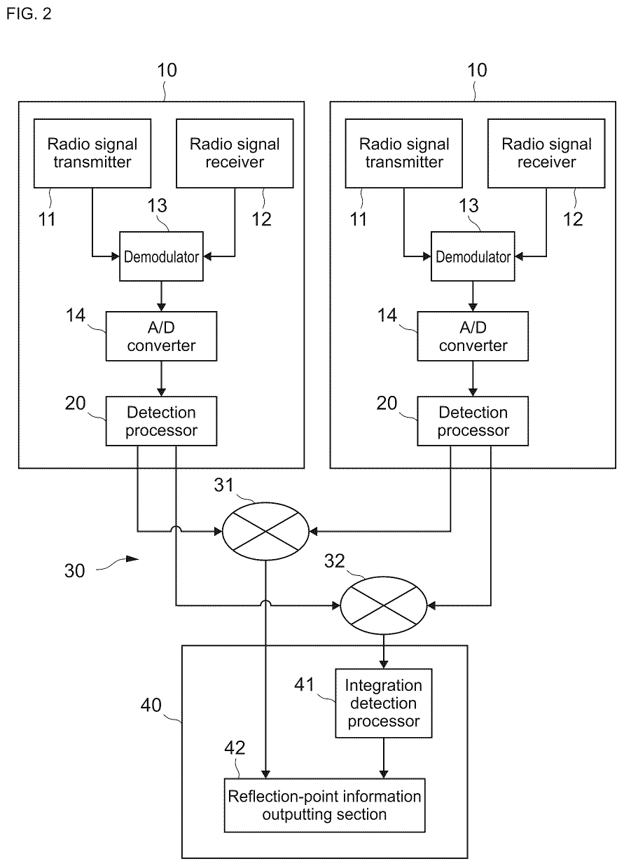

FIG. 2 is a block diagram illustrating an example of a configuration of the information processing system 100.

As illustrated in FIG. 2, the information processing system 100 includes a plurality of radar apparatuses 10, a network 30, and an output apparatus 40. Note that, in the present embodiment, detection of an object that is performed by two radar apparatuses is described as an example. Further, the two radar apparatuses are referred to as a first radar apparatus and a second radar apparatus when they are to be distinguished.

The radar apparatus 10 includes a radio signal transmitter 11, a radio signal receiver 12, a demodulator 13, an A/D converter 14, and a detection processor 20.

The radio signal transmitter 11 generates a transmission signal and emits the generated transmission signal into a space in the form of a transmission wave. In the case of, for example, a fast-chirp-modulation (FCM) radar apparatus, a transmission signal obtained by rapidly repeating a chirp signal showing a linear change in frequency is generated. Further, the radio signal transmitter 11 outputs the transmission signal to the demodulator 13.

The radio signal receiver 12 receives, in the form of a reflected wave, the transmission wave reflected off an object, and outputs a reception signal to the demodulator 13. For example, the radio signal receiver 12 receives the reflected wave using at least one antenna.

The demodulator 13 demodulates the reception signal with the transmission signal, and outputs the demodulated signal to the A/D converter 14. In the present embodiment, the demodulator 13 generates a radar signal that includes a position of a reflection point and speed information regarding a speed of the reflection point, on the basis of the reception signal and the transmission signal. Upon applying the FCM approach, the reception signal and the transmission signal are mixed to obtain the radar signal including a difference frequency. Further, the frequency of the radar signal is proportional to a distance between a reflection point and the radar apparatus 10. An amount of a change in phase between chirps in repetition is proportional to a relative speed of a reflection point relative to the radar apparatus 10.

The A/D converter 14 converts the demodulated signal into a digital value, and outputs a digital radar signal to the detection processor 20. In the present embodiment, the A/D converter 14 samples and quantizes the demodulated signal to generate the digital radar signal. Note that, depending on the radar's approach, a transmission signal and a reception signal may be first converted by the A/D converter 14 into digital signals, and a digital radar signal may be generated by the demodulator 13.

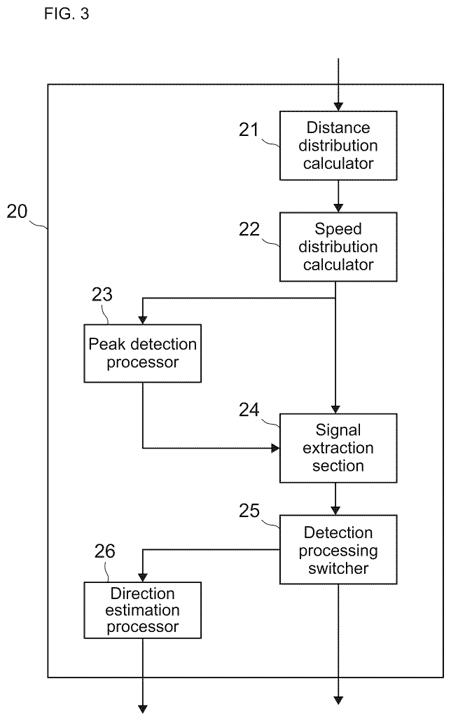

The detection processor 20 determines whether a process of detecting a reflection point on an object is to be performed by use of the radar apparatus 10 or the output apparatus 40. A specific configuration is described with reference to FIG. 3.

In the present embodiment, the detection processor 20 causes, when a distance to the object is less than a specified threshold, the process of detecting a reflection point to be performed by use of the radar apparatus 10. In other words, the detection processor 20 outputs reflection-point information to the output apparatus 40 through a first network 31 when a distance to the object is less than the specified threshold.

Further, the detection processor 20 causes, when the distance to the object is greater than or equal to the specified threshold, the process of detecting a reflection point to be performed by the output apparatus 40. Specifically, the detection processor 20 generates an extraction radar signal obtained by extracting, from an input digital radar signal, components that correspond to a distance to the reflection point and a speed of the reflection point, and outputs the extraction radar signal to the output apparatus 40 through a second network 32.

The reflection-point information and extraction radar signal being output by each of the plurality of radar apparatuses 10 are transmitted to the output apparatus 40 through the network 30. In the present embodiment, the network 30 includes the first network 31 through which the reflection-point information is transmitted from each of the plurality of radar apparatuses 10 to the output apparatus 40, and the second network 32 through which the extraction radar signal is transmitted from each of the plurality of radar apparatuses 10 to the output apparatus 40.

The output apparatus 40 includes an integration detection processor 41 and a reflection-point information outputting section 42.

The integration detection processor 41 performs a process of detecting a reflection point on the basis of an extraction radar signal output by each of the plurality of radar apparatuses 10. In the present embodiment, the integration detection processor 41 estimates, on the basis of the extraction radar signal, a direction in which a reflection point is situated, and outputs reflection-point information to the reflection-point information outputting section.

The reflection-point information outputting section 42 receives the reflection-point information from each of the plurality of radar apparatuses 10 and the integration detection processor 41, and outputs the received reflection-point information to the outside.

FIG. 3 is a block diagram illustrating an example of a configuration of the detection processor 20.

As illustrated in FIG. 3, the detection processor 20 includes a distance distribution calculator 21, a speed distribution calculator 22, a peak detection processor 23, a signal extraction section 24, a detection processing switcher 25, and a direction estimation processor 26.

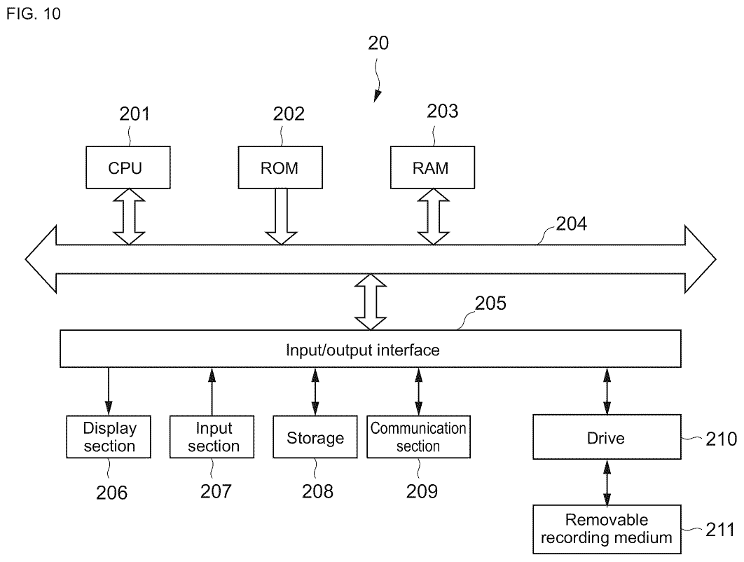

The detection processor 20 includes hardware, such as a processor including a CPU, a GPU, and a DSP; a memory including a ROM and a RAM; and a storage device including an HDD, that is necessary for a configuration of a computer (refer to FIG. 10). For example, an information processing method according to the present technology is performed by the CPU loading, into the RAM, a program according to the present technology that is recorded in, for example, the ROM in advance and executing the program.

For example, the detection processor 20 can be implemented by any computer such as a PC. Of course, hardware such as an FPGA or an ASIC may be used.

In the present embodiment, a detection processing switcher is implemented as a functional block by the CPU executing a specified program. Of course, dedicated hardware such as an integrated circuit (IC) may be used in order to implement the functional block.

The program is installed on the detection processor 20 through, for example, various recording media. Alternatively, the installation of the program may be performed via, for example, the Internet.

The type and the like of a recording medium that records therein a program are not limited, and any computer-readable recording medium may be used. For example, any non-transitory computer-readable recording medium may be used.

The distance distribution calculator 21 converts, into a distance spectrum, a digital radar signal output by the A/D converter 14. In the present embodiment, the distance spectrum obtained by the conversion is supplied to the speed distribution calculator 22.

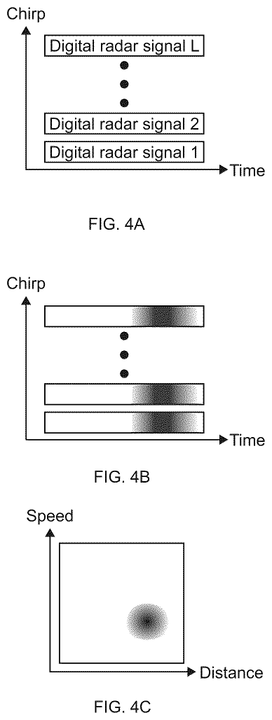

FIG. 4 is a schematic diagram used to describe a state until a peak is detected from a digital radar signal. A of FIG. 4 is a graph on which a digital radar signal obtained by demodulation is given. B of FIG. 4 is a graph on which a distance spectrum is given. C of FIG. 4 is a graph on which a distance-and-speed spectrum is given.

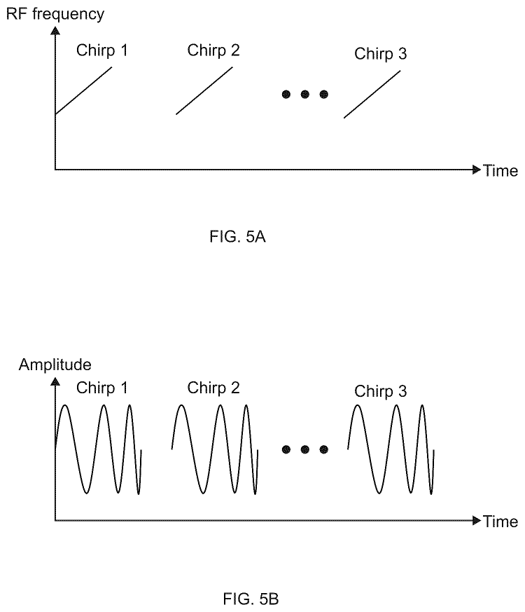

In A and B of FIG. 4, a horizontal axis represents time, and a vertical axis represents frequency. Note that A and B of FIG. 4 each illustrate supplied digital radar signals 1 to L, in order to simplify the description. In other words, it is assumed that a digital radar signal generated due to a chirp signal being transmitted and received, as illustrated in FIG. 5, is displayed in each rectangle.

FIG. 5 is a set of graphs of chirp signals upon applying the FCM approach. A horizontal axis of the graph in A of FIG. 5 represents time, and a vertical axis of the graph represents an RF frequency. Further, a horizontal axis of the graph in B of FIG. 5 represents time, and a vertical axis of the graph represents amplitude.

When, for example, an FCM radar apparatus is used, the frequency of a digital radar signal is proportional to a distance between the radar apparatus and a reflection point. Thus, a distance spectrum can be obtained using Fourier transform with respect to samples in a digital radar signal corresponding to each chirp.

The speed distribution calculator 22 converts the distance spectrum into a distance-and-speed spectrum. In the present embodiment, the distance-and-speed spectrum obtained by the conversion is supplied to the peak detection processor 23 and the signal extraction section 24.

When an FCM radar apparatus is used, distance spectra respectively corresponding to chirp signals repeatedly transmitted, as illustrated in B of FIG. 4, are arranged in a sequence of chirp transmission timings, and fast Fourier transform (FFT) is performed in a direction of the chirp transmission timing. This makes it possible to obtain a distance-and-speed spectrum.

The peak detection processor 23 detects a power peak of a distance-and-speed spectrum to detect a reflection point. In the present embodiment, information regarding a distance to the detected reflection point and a speed of the detected reflection point is supplied to the signal extraction section 24.

The reflection point exists at a distance and speed with a great power strength on a distance-and-speed spectrum. A horizontal axis of the graph in C of FIG. 4 represents distance, and a vertical axis of the graph represents speed. As illustrated in FIG. 4, for example, the peak detection processor 23 calculates the square of an absolute value of a complex signal, that is, a power level at each distance to a distance-and-speed spectrum corresponding to the complex signal at each speed of the distance-and-speed spectrum. Then, a position of a peak of the power level is detected by, for example, constant false alarm rate (CFAR) detecting processing.

The signal extraction section 24 extracts, from distance-and-speed spectra, components that respectively correspond to a distance to a reflection point and a speed of the reflection point. Note that the signal extraction section 24 generates a plurality of complex signals for a certain distance and a certain speed since a plurality of distance-and-speed spectra is generated when the radio signal transmitter 11 or the radio signal receiver 12 uses a plurality of antennas. In the present embodiment, the signal extraction section 24 supplies an extraction radar signal to the detection processing switcher 25.

The detection processing switcher 25 outputs the extraction radar signal to the direction estimation processor 26 or the output apparatus 40 in accordance with predetermined criteria. In the present embodiment, the detection processing switcher 25 performs switching on a detection process on the basis of whether an object exhibits a value that is less than a specified threshold.

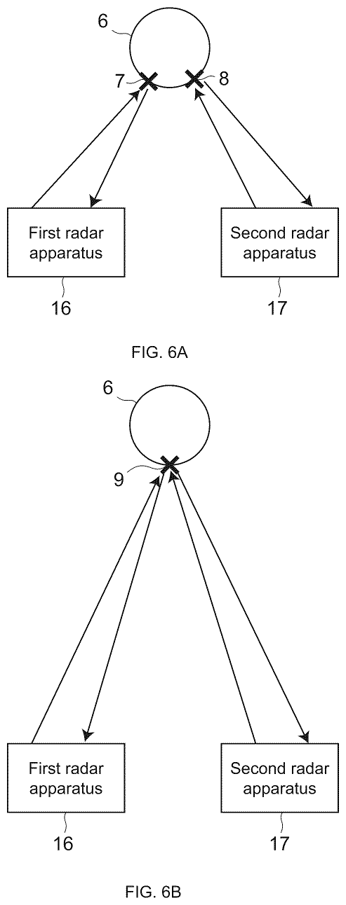

FIG. 6 schematically illustrate a short-distance object detection performed using a plurality of radar apparatuses and a long-distance object detection performed using the plurality of radar apparatuses. A of FIG. 6 schematically illustrates the short-distance object detection. B of FIG. 6 schematically illustrates the long-distance object detection.

When an object 6 is situated at a short distance from a first radar apparatus 16 and a second radar apparatus 17, as illustrated in A of FIG. 6, the respective radar apparatuses may observe reflected waves respectively reflected at different reflection points (7 and 8) on one object 6. In this case, the radar apparatuses each perform a process of detecting a reflection point for a digital radar signal. Pieces of reflection-point information regarding the reflection points are put together, and this makes it possible to obtain pieces of information regarding the different reflection points 7 and 8 of a plurality of reflection points on the object 6. In other words, information useful in estimating a region occupied by an object can be obtained.

When the object 6 is situated at a long distance from the first radar apparatus 16 and the second radar apparatus 17, as illustrated in B of FIG. 6, the respective radar apparatuses may observe a reflected wave reflected at one reflection point 9 on the object 6. In this case, pieces of reflection-point information obtained by the radar apparatuses indicate one reflection point. This results in difficulty in obtaining different pieces of reflection-point information of a plurality of pieces of reflection-point information by the pieces of obtained reflection-point information being collected.

In the present embodiment, when the object 6 is situated at a long distance from the first radar apparatus 16 and the second radar apparatus 17 (when radar apparatuses of a plurality of radar apparatuses observe a reflected wave reflected at one reflection point 9), digital radar signals from the respective radar apparatuses are collected, and then a process of detecting the reflection point 9 is performed. This makes it possible to improve the detection accuracy.

In particular, when phase synchronization between radar apparatuses of a plurality of radar apparatuses is ensured with a high degree of accuracy, a coherent process using a plurality of radar apparatuses 10 as a single array antenna makes it possible to perform a process of estimating a direction at high resolution with a high degree of accuracy.

The direction estimation processor 26 estimates, from an extraction radar signal, a direction in which there exists a reflection point. In other words, the direction estimation processor 26 generates reflection-point information including a distance to a reflection point, a speed of the reflection point, and a direction of the reflection point, and outputs the generated reflection-point information to the output apparatus 40.

Note that, in the present embodiment, the detection processor 20 corresponds to an information processing apparatus that includes a distance calculator used to calculate a distance to an object, the calculation of the distance being performed using at least one of a plurality of radar apparatuses; and a processor that causes, when the distance to the object is less than a specified threshold, a process of detecting different reflection points on the object to be performed, the detections of the different reflection points on the object being performed by use of respective radar apparatuses of the plurality of radar apparatuses, and that causes, when the distance to the object is greater than or equal to the specified threshold, a process of detecting an in-common reflection point on the object to be performed, the detection of the in-common reflection point on the object being performed by digital radar signals from the respective radar apparatuses of the plurality of radar apparatuses being combined.

Note that, in the present embodiment, the distance distribution calculator 21 corresponds to the distance calculator used to calculate the distance to the object, the calculation of the distance being performed using at least one of the plurality of radar apparatuses.

Note that, in the present embodiment, the detection processing switcher 25 corresponds to a switcher that switches between the process of detecting the different reflection points on the object by use of the respective radar apparatuses of the plurality of radar apparatuses, and the process of detecting the in-common reflection point on the object by the digital radar signals from the respective radar apparatuses of the plurality of radar apparatuses being combined, the detections of the different reflection points on the object being performed on the basis of first estimation results respectively obtained by pieces of reflection-point information being estimated by respective first estimators, the detection of the in-common reflection point on the object being performed on the basis of a second estimation result obtained by reflection-point information being estimated by a second estimator.

Note that, in the present embodiment, the direction estimation processor 26 corresponds to the first estimator estimating the reflection-point information regarding the different reflection point on the basis of a radar signal related to the object when the distance to the object is less than the specified threshold.

Note that, in the present embodiment, the output apparatus 40 corresponds to an output apparatus that includes an output section that outputs the reflection-point information regarding the reflection point on the basis of the detection processes performed by the processors.

Note that, in the present embodiment, the integration detection processor 41 corresponds to a second estimator estimating the reflection-point information regarding the in-common reflection point on the basis of radar signals related to the object when the distance to the object is greater than or equal to the specified threshold.

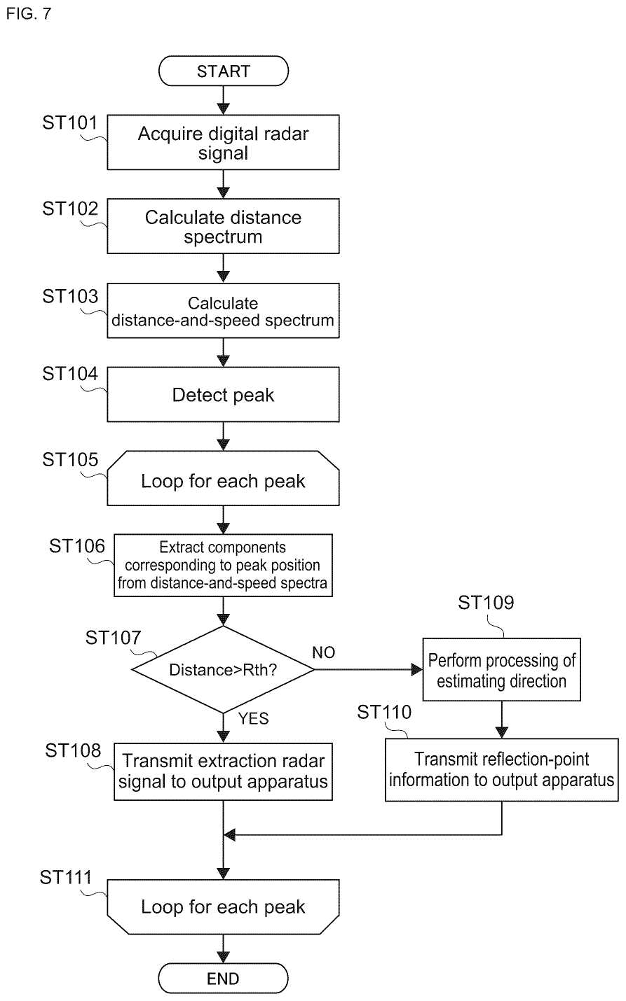

FIG. 7 is a flowchart illustrating an operation of the detection processor 20.

As illustrated in FIG. 7, the distance distribution calculator 21 acquires a digital radar signal (Step 101), and a distance spectrum is calculated (Step 102).

The speed distribution calculator 22 calculates a distance-and-speed spectrum from the distance spectrum (Step 103).

The peak detection processor 23 detects a peak in order to obtain a distance to a reflection point and a speed of the reflection point (Step 104). Typically, a plurality of peaks is detected in Step 104. In other words, the processes of Steps 105 to 111 are performed for each of the detected peaks.

The signal extraction section 24 extracts, from the distance-and-speed spectra, a complex signal for a distance and a speed that correspond to a peak position (Step 106).

The detection processing switcher 25 determines whether a process of estimating a direction of a reflection point is to be performed by the radar apparatus 10 or the output apparatus 40 (Step 107). In the present embodiment, the detection processing switcher 25 performs switching on the process on the basis of whether a distance between an object and the radar apparatus is less than a specified threshold Rth.

When a distance at which a peak of a reflection point is situated is greater than or equal to the threshold Rth (YES in Step 107), an extraction radar signal is transmitted to the output apparatus 40 (Step 108). In other words, the integration detection processor 41 performs the process of estimating a direction of a reflection point.

When the distance at which a peak of a reflection point is situated is less than the threshold Rth (NO in Step 107), an extraction radar signal is transmitted to the direction estimation processor 26. The direction estimation processor 26 performs the process of estimating a direction of a reflection point, on the basis of the extraction radar signal (Step 109). Specifically, using phase-difference information regarding a phase difference between complex signals respectively corresponding to antennas of a plurality of antennas, the direction estimation processor 26 estimates a direction in which a reflection point is situated by use of a direction-of-arrival estimating algorithm such as a digital beamforming technique or multiple signal classification (MUSIC).

A method for setting the specified threshold Rth is not limited, and setting may be performed by any method. For example, a width for setting a radar apparatus may be multiplied by a specified coefficient, and setting may be performed on the basis of the width for setting a radar apparatus.

Further, switching may be performed on the detection process, on the basis of a factor other than the distance to an object. When, for example, objects of a plurality of objects are detected at different angles as a result of a direction estimation process performed by the integration detection processor 41 of the output apparatus 40, the output apparatus 40 may perform a process of estimating a direction of a reflection point.

Further, the output apparatus 40 may perform the process of estimating a direction of a reflection point when, for example, the number of reflection points detected by the integration detection processor 41 performing direction estimation is larger than an average of the numbers of reflection points detected by the respective radar apparatuses as a result of the direction estimation processor 26 performing direction estimation. For example, in FIG. 1, an average of the detection numbers is two in a left portion of FIG. 1 since there are six reflection points and the number of radar apparatuses is three, whereas an average of the detection numbers is two in a right portion of FIG. 1 since there are two reflection points. In this case, the respective averages exhibit the same number. Thus, the direction estimation processor 26 may perform the process of estimating a direction of a reflection point.

Moreover, with respect to Rth, a condition that is “Rth1 for an overlap region<R (a distance to an object)<Rth2” is set, and switching may be performed on the detection process on the basis of the setting. Further, when, for example, a result of detection performed by the direction estimation processor 26 shows that there is a combination of reflection points in which a distance (Δd) to and a speed (Δv) of one of the reflection points are respectively close to a distance (Δd) to and a speed (Δv) of another of the reflection points, it is determined that the radar apparatuses may be observing the same reflection point, and switching may be performed on the detection process according to the combination of reflection points. In other words, switching may be performed on the detection process on the basis of which of a threshold (Dth) for a specified distance and Δd is larger, and on the basis of which of a threshold (Vth) for a specified speed and Δv is larger. Further, for example, control to perform switching on the detection process may be performed on all of the detection regions of detection performed by a plurality of radar apparatuses.

The direction estimation processor 26 transmits reflection-point information to the output apparatus 40 (Step 110). In Step 108 or 110, the reflection-point information is supplied to the reflection-point information outputting section 42.

As described above, in the information processing system 100 according to the present embodiment, distances from radar apparatuses 10 of a plurality of radar apparatuses 10 to the object 1 are calculated. When the distances to the object 1 are less than a specified threshold Rth, a process of detecting different reflection points 2 on the object 1 by use of the respective radar apparatuses of the plurality of radar apparatuses 10, is performed. When the distances to the object 1 are greater than or equal to the specified threshold Rth, a process of detecting an in-common reflection point 3 on the object 1 by digital radar signals from the radar apparatuses 10 of the plurality of radar apparatuses 10 being combined, is performed. This makes it possible to detect an object with a high degree of accuracy.

Conventionally, a plurality of radar apparatuses is included in a mobile object to improve the accuracy in monitoring. However, when an object is situated at a long distance upon object detection, the respective radar apparatuses of the plurality of radar apparatuses observe a reflection point on the object that is situated at the same position. This results in difficulty in improving the accuracy in estimation even if pieces of reflection-point information are collected.

According to the present technology, when the object is situated at a short distance, the accuracy can be improved by the respective radar apparatuses of the plurality of radar apparatuses detecting different reflection points on one object. When the object is situated at a long distance, the position of the object can be detected with a high degree of accuracy by the radar apparatuses of the plurality of radar apparatuses being integrated. Further, signal processing burdens in the radar apparatus can be reduced by the radar apparatus and the output apparatus each taking partial charge of a process of detecting a reflection point. Furthermore, the radar apparatus can be made smaller in size and manufactured at low costs. Further, a radar signal is extracted by the radar apparatus to be transmitted to the output apparatus. This makes it possible to reduce necessary throughput in a network between the radar apparatus and the output apparatus.

### Other Embodiments

The present technology is not limited to the embodiments described above, and can achieve various other embodiments.

In the embodiments described above, the detection processing switcher 25 determines whether a process of estimating a direction of a reflection point is to be performed by the direction estimation processor 26 of the radar apparatus 10 or the integration detection processor 41 of the output apparatus 40. Without being limited thereto, switching between the radar apparatus 10 and the output apparatus 40 may also be performed on a process that is other than the direction estimation process and corresponds to another factor included in the process of detecting a reflection point, where examples of the other factor include calculation of a distance spectrum, calculation of a distance-and-speed spectrum, and detection of a peak.

In the embodiments described above, switching is performed on the process of estimating a direction of a reflection point, on the basis of a distance to an object. Without being limited thereto, switching may be performed on the direction estimation process, on the basis of other conditions. For example, the radar apparatus may alternately transmit a transmission wave used for short-distance measurement and a transmission wave used for long-distance measurement, the radar apparatus may perform a process of detecting a reflection point for a digital radar signal corresponding to the transmission wave used for short-distance measurement, and the output apparatus may perform a process of detecting a reflection point for a digital radar signal that corresponds to the transmission wave used for long-distance measurement.

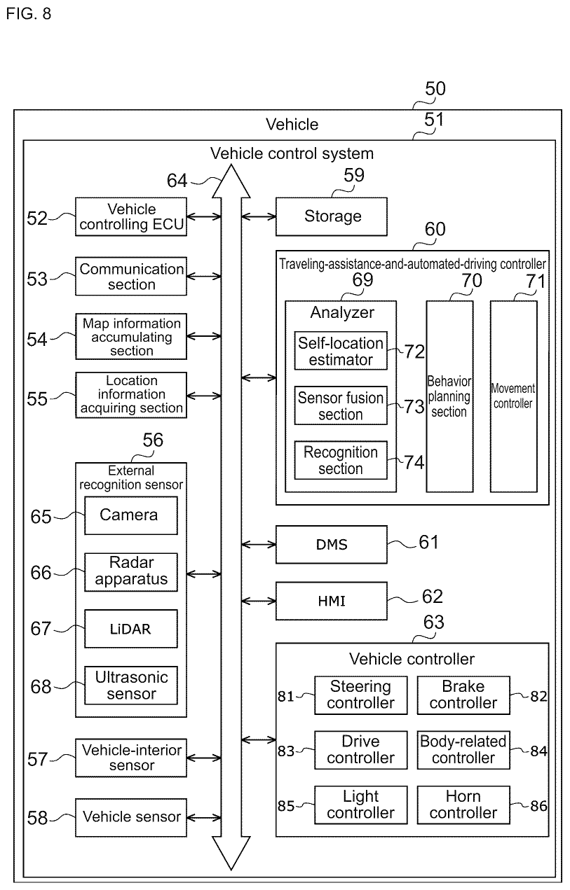

In the embodiments described above, a plurality of radar apparatuses 10 is arranged at a fixed location in, for example, a mobile object or an intersection. FIG. 8 illustrates an example of a block diagram when the plurality of radar apparatuses 10 is included in a vehicle. In other words, an example of applying the information processing system 100 to a vehicle 50 and a vehicle control system 51 is illustrated.

### [Example of Configuration of Vehicle Control System]

FIG. 8 is a block diagram illustrating an example of a configuration of the vehicle control system 51 corresponding to an example of an information processing system to which the present technology is applied.

The vehicle control system 51 is provided to the vehicle 50, and performs a process related to traveling assistance for the vehicle 50 and a process related to automated driving of the vehicle 50.

The vehicle control system 51 includes a vehicle controlling electronic control unit (ECU) 52, a communication section 53, a map information accumulating section 54, a location information acquiring section 55, an external recognition sensor 56, a vehicle-interior sensor 57, a vehicle sensor 58, a storage 59, a traveling-assistance-and-automated-driving controller 60, a driver monitoring system (DMS) 61, a human machine interface (HMI) 62, and a vehicle controller 63.

The vehicle controlling ECU 52, the communication section 53, the map information accumulating section 54, the location information acquiring section 55, the external recognition sensor 56, the vehicle-interior sensor 57, the vehicle sensor 58, the storage 59, the traveling-assistance-and-automated-driving controller 60, the driver monitoring system (DMS) 61, the human machine interface (HMI) 62, and the vehicle controller 63 are connected to each other through a communication network 64 to be capable of communicating with each other.

For example, the communication network 64 includes, for example, a vehicle-mounted communication network or bus that is compliant with digital two-way communication standards, where examples of the communication network 64 include a controller area network (CAN), a local interconnect network (LIN), a local area network (LAN), FlexRay (registered trademark), and Ethernet (registered trademark). The examples of the communication network 64 may be selectively used depending on the type of data to be transmitted. For example, CAN may be applied to data related to vehicle control, and Ethernet may be applied to large volumes of data. Note that structural elements of the vehicle control system 51 may be directly connected to each other without using the communication network 64, but using wireless communication, such as near field communication (NFC) or Bluetooth (registered trademark), that is provided on the assumption of communication at a relatively short distance.

Note that the description of the communication network 64 will be omitted below when the respective structural elements of the vehicle control system 51 communicate with each other through the communication network 64. For example, when the vehicle controlling ECU 52 and the communication section 53 communicate with each other through the communication network 64, it will be simply stated that the vehicle controlling ECU 52 and the communication section 53 communicate with each other.

For example, the vehicle controlling ECU 52 includes various processors such as a central processing unit (CPU) and a micro processing unit (MPU). The vehicle controlling ECU 52 performs control on all of or a portion of functions of the vehicle control system 51.

The communication section 53 communicates with various vehicle-interior-and-exterior apparatuses, another vehicle, a server, a base station, and the like, and performs transmission and reception of various data. Here, the communication section 53 can perform communication using a plurality of communication approaches.

A vehicle-exterior communication that can be performed by the communication section 53 is schematically described. For example, the communication section 53 communicates with, for example, a server (hereinafter referred to as an external server) situated in an external network through a base station or an access point, using a wireless communication approach such as the 5th generation mobile communication system (5G), Long Term Evolution (LTE), or dedicated short range communications (DSRC). Examples of the external network with which the communication section 53 communicates include the Internet, a cloud network, or a carrier-specific network. The approach of communication performed by the communication section 53 with respect to the external network is not particularly limited, and any wireless communication approach that enables digital two-way communication with a certain distance at a certain communication rate may be adopted as the communication approach, the certain distance being greater than or equal to a specified distance, the certain communication rate being greater than or equal to a specified communication rate.

Further, for example, the communication section 53 can communicate with a terminal situated near an own automobile, using a peer-to-peer (P2P) technology. Examples of the terminal situated near the own automobile include a terminal that is attached to a mobile object such as a pedestrian or a bicycle that moves at a relatively slow speed, a terminal placed at a fixed location in, for example, a store, and a machine-type communication (MTC) terminal. Furthermore, the communication section 53 can also perform V2X communication. The V2X communication refers to communication between the own vehicle and anything, such as vehicle-to-vehicle communication with another vehicle, vehicle-to-infrastructure communication with, for example, a roadside unit, vehicle-to-home communication with a home, and vehicle-to-pedestrian communication with, for example, a terminal of a pedestrian.

For example, the communication section 53 can receive, from the outside, a program used to update software used to control an operation of the vehicle control system 51 (over the air). Further, the communication section 53 can receive, from the outside, map information, traffic information, information regarding surroundings of the vehicle 50, and the like. Furthermore, for example, the communication section 53 can transmit, to the outside, information regarding the vehicle 50, and the information regarding surroundings of the vehicle 50. Examples of the information regarding the vehicle 50 that is transmitted to the outside by the communication section 53 include data indicating a state of the vehicle 50, and a result of recognition performed by a recognition section 74. Further, for example, the communication section 53 performs communication associated with a vehicle emergency alerting system such as an ecall.

For example, the communication section 53 receives an electromagnetic wave transmitted by the Vehicle Information and Communication System (VICS) (registered trademark) using, for example, a radio wave beacon, an infrared beacon, and FM multiplex broadcasting.

A vehicle-interior communication that can be performed by the communication section 53 is briefly described. For example, the communication section 53 can communicate with each vehicle-interior apparatus wirelessly. The communication section 53 can communicate with a vehicle-interior apparatus wirelessly using a communication approach that makes it possible to perform digital two-way communication wirelessly at a certain communication rate that is greater than or equal to a specified communication rate, where examples of the communication approach include a wireless LAN, Bluetooth, NFC, and a wireless USB (WUSB). Without being limited thereto, the communication section 53 can also communicate with each vehicle-interior apparatus by wire. For example, the communication section 53 can communicate with a vehicle-interior apparatus by wire through a cable that is connected to a connection terminal (not illustrated).

The communication section 53 can communicate with a vehicle-interior apparatus by wire using a communication approach that makes it possible to perform digital two-way communication by wire at a certain communication rate that is greater than or equal to a specified communication rate, where examples of the communication approach include a universal serial bus (USB), a high-definition multimedia interface (HDMI) (registered trademark), and a mobile high-definition link (MHL).

Here, the vehicle-interior apparatus refers to, for example, an apparatus that is not connected to the communication network 64 in the vehicle. For example, a mobile apparatus or a wearable apparatus of a person on board such as a driver, and an information apparatus that is brought in the vehicle to be temporarily placed in the vehicle are assumed to be the vehicle-interior apparatus.

The map information accumulating section 54 accumulates therein one of or both a map acquired from the outside and a map created by the vehicle 50. For example, the map information accumulating section 54 accumulates therein, for example, a three-dimensional high-precision map, and a global map that is less precise and covers a wider area than the high-precision map.

Examples of the high-precision map include a dynamic map, a point cloud map, and a vector map. For example, the dynamic map is a map that includes four groups of pieces of information that are dynamic information, quasi-dynamic information, quasi-static information, and static information, and the dynamic map is provided to the vehicle 50 by, for example, an external server. The point cloud map is a map that includes point cloud (group-of-points data). For example, the vector map is a map that is adapted to an advanced driver assistance system (ADAS) and autonomous driving (AD) by traffic information or the like such as locations of lanes and traffic lights being plotted on the point cloud map.

The point cloud map and the vector map may be provided by, for example, an external server. Alternatively, on the basis of results of sensing performed by, for example, a camera 65, a radar apparatus 66, and LiDAR 67, the point cloud map and the vector map may be created by the vehicle 50 as maps used to perform matching on a local map described later, and may be accumulated in the map information accumulating section 54. Further, for example, data of a map several hundred kilometers square with respect to a planned route on which the vehicle 50 is going to travel is acquired from, for example, an external server when the high-precision map is provided by, for example, the external server, in order to reduce the communication capacity.

The location information acquiring section 55 receives a global navigation satellite system (GNSS) signal from a GNSS satellite, and acquires location information regarding a location of the vehicle 50. The acquired location information is supplied to the traveling-assistance-and-automated-driving controller 60. Note that the acquisition of location information is not limited to the approach using a GNSS signal, and the location information acquiring section 55 may acquire the location information using, for example, a beacon.

The external recognition sensor 56 includes various sensors used to recognize a state outside of the vehicle 50, and supplies the structural elements of the vehicle control system 51 with pieces of sensor data from the respective sensors. The external recognition sensor 56 may include any type of sensor and any number of sensors.

For example, the external recognition sensor 56 includes the camera 65, the radar apparatus 66, the LiDAR (light detection and ranging, laser imaging detection and ranging) 67, and an ultrasonic sensor 68. Without being limited thereto, the external recognition sensor 56 may include at least one type of sensor from among the camera 65, the radar apparatus 66, the LiDAR 67, and the ultrasonic sensor 68. Any numbers of cameras 65, radar apparatuses 66, LiDAR 67, and ultrasonic sensors 68 that can be actually placed in the vehicle 50 may be acceptable. Further, the type of sensor included in the external recognition sensor 56 is not limited to this example, and the external recognition sensor 56 may include any other type of sensor. An example of a region of sensing performed by each sensor of the external recognition sensor 56 will be described later. Note that an image-capturing approach adopted by the camera 65 is not particularly limited. For example, cameras adopting various image-capturing approaches can be applied to the camera 65 as necessary, where examples of the cameras adopting various image-capturing approaches include a time-of-flight (ToF) camera, a stereo camera, a monocular camera, and an infrared camera that adopt image-capturing approaches that make it possible to perform ranging. Without being limited thereto, the camera 65 may be simply used to acquire a captured image regardless of ranging.

Further, for example, the external recognition sensor 56 may include an environment sensor used to detect an environment surrounding the vehicle 50. The environment sensor is a sensor used to detect an environment related to, for example, weather, a meteorological phenomenon, and brightness, and examples of the environment sensor may include various sensors such as a raindrop sensor, a fog sensor, a sunlight sensor, a snow sensor, and an illumination intensity sensor.

Further, for example, the external recognition sensor 56 includes a microphone used to, for example, detect sound around the vehicle 50 and a location of a sound source.

The vehicle-interior sensor 57 includes various sensors used to detect information regarding the inside of a vehicle, and supplies the structural elements of the vehicle control system 51 with pieces of sensor data from the respective sensors. Any types and any numbers of various sensors included in the vehicle-interior sensor 57 that can be actually placed in the vehicle 50 may be acceptable.

For example, the vehicle-interior sensor 57 may include at least one type of sensor from among a camera, a radar apparatus, a seating sensor, a steering wheel sensor, a microphone, and a biological sensor. A camera, such as a time-of-flight (ToF) camera, a stereo camera, a monocular camera, or an infrared camera, that adopts an image-capturing approach that makes it possible to perform ranging may be used as the camera included in the vehicle-interior sensor 57. Without being limited thereto, the camera included in the vehicle-interior sensor 57 may be simply used to acquire a captured image regardless of ranging. The biological sensor included in the vehicle-interior sensor 57 is provided to, for example, a seat or a steering wheel, and detects various biological information regarding a person on board such as a driver.

The vehicle sensor 58 includes various sensors used to detect a state of the vehicle 50, and supplies the structural elements of the vehicle control system 51 with pieces of sensor data from the respective sensors. Any types and any numbers of various sensors included in the vehicle sensor 58 that can be actually placed in the vehicle 50 may be acceptable.

For example, the vehicle sensor 58 includes a speed sensor, an acceleration sensor, an angular velocity sensor (a gyroscope), and an inertial measurement unit (IMU) obtained by combining these sensors. For example, the vehicle sensor 58 includes a steering angle sensor that detects a steering angle of a steering wheel, a yaw rate sensor, an accelerator sensor that detects an amount of operation of a gas pedal, and a brake sensor that detects an amount of operation of a brake pedal. For example, the vehicle sensor 58 includes a rotation sensor that detects the number of revolutions of an engine and the number of revolutions of a motor, a pneumatic sensor that detects a tire pressure, a slip ratio sensor that detects a slip ratio of a tire, and a wheel speed sensor that detects a speed of wheel rotation. For example, the vehicle sensor 58 includes a battery sensor that detects a remaining battery life and a temperature of a battery, and an impact sensor that detects an impact imposed from the outside.

The storage 59 includes at least one of a nonvolatile storage medium or a volatile storage medium, and stores therein data and a program. The storage 59 is used as, for example, an electrically erasable programmable read only memory (EEPROM) or a random access memory (RAM), and a magnetic storage device such as a hard disc drive (HDD), a semiconductor storage device, an optical storage device, or a magneto-optical storage device can be applied as the storage medium. The storage 59 stores therein various programs and data used by the respective structural elements of the vehicle control system 51. For example, the storage 59 includes an event data recorder (EDR) or a data storage system for automated driving (DSSAD), and stores therein information regarding the vehicle 50 before and after events such as accidents, and information acquired by the vehicle-interior sensor 57.

The traveling-assistance-and-automated-driving controller 60 controls traveling assistance for the vehicle 50 and automated driving of the vehicle 50. For example, the traveling-assistance-and-automated-driving controller 60 includes an analyzer 69, a behavior planning section 70, and a movement controller 71.

The analyzer 69 performs a process of analyzing states of the vehicle 50 and its surroundings. The analyzer 69 includes a self-location estimator 72, a sensor fusion section 73, and the recognition section 74.

The self-location estimator 72 estimates a self-location of the vehicle 50 on the basis of sensor data from the external recognition sensor 56 and a high-precision map accumulated in the map information accumulating section 54. For example, the self-location estimator 72 generates a local map on the basis of the sensor data from the external recognition sensor 56, and performs matching on the local map and the high-precision map to estimate the self-location of the vehicle 50. The location of the vehicle 50 is based on, for example, the middle of an axle for a rear pair of wheels.

Examples of the local map include a three-dimensional high-precision map created using a technology such as simultaneous localization and mapping (SLAM), and an occupancy grid map. Examples of the three-dimensional high-precision map include the point cloud map described above. The occupancy grid map is a map that indicates an occupation state of an object for each grid cell by dividing a three- or two-dimensional space around the vehicle 50 into grid cells of a specified size. For example, the occupation state of an object is represented by the presence or absence of the object or the probability of existence of the object. For example, the local map is also used to perform a process of detecting a state outside of the vehicle 50 and a process of recognizing the outside state, the detection process and recognition process being performed by the recognition section 74.

Note that the self-location estimator 72 may estimate a self-location of the vehicle 50 on the basis of location information acquired by the location information acquiring section 55 and sensor data from the vehicle sensor 58.

The sensor fusion section 73 combines different types of pieces of sensor data of a plurality of pieces of sensor data (such as image data supplied by the camera 65 and sensor data supplied by the radar apparatus 66), and performs a sensor-fusion process to obtain new information. Examples of a method for combining different types of pieces of sensor data include integration, fusion, and federation.

The recognition section 74 performs a detection process of detecting a state outside of the vehicle 50 and a recognition process of recognizing the state outside of the vehicle 50.

For example, on the basis of, for example, information from the external recognition sensor 56, information from the self-location estimator 72, and information from the sensor fusion section 73, the recognition section 74 performs the detection process of detecting a state outside of the vehicle 50 and the recognition process of recognizing the outside state.

Specifically, for example, the recognition section 74 performs, for example, a process of detecting an object situated around the vehicle 50 and a process of recognizing the object. Examples of the process of detecting an object include a process of detecting, for example, the presence or absence of an object, a size of the object, a shape of the object, a location of the object, and movement of the object. Examples of the process of recognizing an object include a process of recognizing an attribute of an object such as the type of object, and a process of recognizing a specified object. However, the detection process and the recognition process are not necessarily clearly distinguished from each other, and may overlap.

For example, the recognition section 74 clusters point cloud based on sensor data from, for example, the radar apparatus 66 or the LiDAR 67 into groups of points to detect an object situated around the vehicle 50. This results in detecting the presence or absence of an object situated around the vehicle 50, a size of the object, a shape of the object, and a location of the object.

For example, the recognition section 74 tracks movement of the group of points obtained by the clustering to detect movement of an object situated around the vehicle 50. This results in detecting a speed of and a traveling direction (a movement vector) of an object situated around the vehicle 50.

For example, the recognition section 74 detects or recognizes, for example, a vehicle, a person, a bicycle, an obstacle, a structure, a road, a traffic light, a traffic sign, and a road sign on the basis of image data supplied by the camera 65. Further, the recognition section 74 may perform a recognition process such as semantic segmentation to recognize the type of object situated around the vehicle 50.

For example, the recognition section 74 can perform a process of recognizing traffic rules around the vehicle 50 on the basis of a map accumulated in the map information accumulating section 54, a result of estimation of a self-location that is performed by the self-location estimator 72, and a result of recognition of an object situated around the vehicle 50 that is performed by the recognition section 74. As a result of the recognition process, the recognition section 74 can recognize, for example, a location and a state of a traffic light, details of a traffic sign and a road sign, details of traffic control, and a travelable lane.

For example, the recognition section 74 can perform a process of recognizing an environment surrounding the vehicle 50. Examples of a conceivable surrounding environment to be recognized by the recognition section 74 include weather, temperature, humidity, brightness, and a road surface condition.

The behavior planning section 70 creates a plan of the behavior of the vehicle 50. For example, the behavior planning section 70 performs a route planning process and a route tracking process to create the behavior plan.

Note that the route planning (global path planning) is a process of roughly planning a route from a start to a goal. This route planning also includes a process of trajectory creation (local path planning) that is called trajectory planning, where the trajectory makes it possible to travel safely and smoothly near the vehicle 50 in the planned route in consideration of motion characteristics of the vehicle 50.

The route tracking is a process of planning movement to be performed to travel safely and accurately on a route planned by route planning within a time planned by the route planning. For example, the behavior planning section 70 can calculate a target speed for and a target angular velocity for the vehicle 50 on the basis of a result of the route tracking process.

The movement controller 71 controls movement of the vehicle 50 in order to implement the behavior plan created by the behavior planning section 70.

For example, the movement controller 71 controls a steering controller 81, a brake controller 82, and a drive controller 83 that are included in the vehicle controller 63 described later to control acceleration/deceleration and a direction such that the vehicle 50 travels along a trajectory planned by trajectory planning. For example, the movement controller 71 performs a cooperative control intended to implement a function of ADAS including collision avoidance or shock mitigation, traveling after a leading vehicle, traveling while maintaining a vehicle speed, a warning of collision of the own automobile, and a warning of deviation of the own automobile from a lane. For example, the movement controller 71 performs a cooperative control intended to achieve, for example, automated driving that is autonomously traveling without an operation performed by a driver.

The DMS 61 performs, for example, a process of authenticating a driver and a process of recognizing a state of the driver on the basis of, for example, sensor data from the vehicle-interior sensor 57 and input data input through the HMI 62 described later. Examples of a conceivable recognition-target state of a driver include a physical condition, a degree of arousal, a degree of concentration, a degree of fatigue, a direction of a line of sight, a degree of drunkenness, a driving operation, and a pose.

Note that the DMS 61 may perform a process of authenticating a person on board other than a driver and a process of recognizing a state of the person on board. Further, for example, the DMS 61 may perform a process of recognizing a vehicle-interior state on the basis of sensor data from the vehicle-interior sensor 57. Examples of a conceivable recognition-target vehicle-interior state include temperature, humidity, brightness, and odor.

Various pieces of data, instructions, and the like are input through the HMI 62, and the various data is presented to, for example, a driver through the HMI 62.

The input of data through the HMI 62 is briefly described. The HMI 62 includes an input device used by a person to input data. The HMI 62 generates an input signal on the basis of data, an instruction, or the like input through the input device, and supplies the generated input signal to the respective structural elements of the vehicle control system 51. The HMI 62 includes, as the input device, an operator such as a touch panel, a button, a switch, and a lever. Without being limited thereto, the HMI 62 may further include an input device with which information can be input by a method, such as sound or a gesture, that is other than a manual operation.

Further, the HMI 62 may use, as the input device, an externally connected apparatus such as a remote-control apparatus using infrared light or radio waves, or a mobile or wearable apparatus compatible with an operation of the vehicle control system 51.

The data presentation performed by the HMI 62 is briefly described. The HMI 62 generates visual information, auditory information, and tactile information to be provided to a person on board or to the outside of a vehicle. Further, the HMI 62 performs output control that is controlling, for example, output of the pieces of generated information, the details of the output, a timing of performing the output, and a method for performing the output. As the visual information, the HMI 62 generates and outputs information, such as an operation screen, display of a state of the vehicle 50, display of warning, and a monitoring image indicating a state around the vehicle 50, that is provided using an image or light. Further, as the auditory information, the HMI 62 generates and outputs information, such as voice guidance, a warning beep, and a warning message, that is provided by sound. Furthermore, as the tactile information, the HMI 62 generates and outputs information provided to a person on board through a tactile sense using, for example, force, oscillation, and movement.

For example, a display apparatus that displays thereon an image to present visual information, or a projector apparatus that projects an image to present visual information can be applied as an output device to which the HMI 62 outputs visual information. Note that, in addition to a display apparatus including a commonly used display, the display apparatus may be an apparatus, such as a wearable device including a head-up display, a transmissive display, or an augmented reality (AR) function, that displays visual information in a field of view of a person on board. Further, the HMI 62 can also use, as the output device to which visual information is output, a display device included in, for example, a navigation apparatus, an instrument panel, a camera monitoring system (CMS), an electronic mirror, or a lamp that is provided to the vehicle 50.

For example, an audio speaker, headphones, or earphones can be applied as the output device to which the HMI 62 outputs auditory information.

For example, a haptic element using a haptic technology can be applied as the output device to which the HMI 62 outputs tactile information. For example, the haptic element is provided to a portion of the vehicle 50, such as a steering wheel or a seat, with which a person on board comes into contact.

The vehicle controller 63 controls respective structural elements of the vehicle 50. The vehicle controller 63 includes the steering controller 81, the brake controller 82, the drive controller 83, a body-related controller 84, a light controller 85, and a horn controller 86.

For example, the steering controller 81 detects and controls a state of a steering system of the vehicle 50. The steering system includes, for example, a steering mechanism including, for example, a steering wheel, and electric power steering. The steering controller 81 includes, for example, a steering ECU that controls the steering system, and an actuator that drives the steering system.

For example, the brake controller 82 detects and controls a state of a brake system of the vehicle 50. The brake system includes, for example, a brake mechanism including, for example, a brake pedal, an antilock braking system (ABS), and a regeneration brake mechanism. The brake controller 82 includes, for example, a brake ECU that controls the brake system, and an actuator that drives the brake system.

For example, the drive controller 83 detects and controls a state of a drive system of the vehicle 50. The drive system includes, for example, a gas pedal, a driving force generating apparatus, such as an internal-combustion engine or a driving motor, that is used to generate driving force, and a driving force transmitting mechanism used to transmit the driving force to wheels. The drive controller 83 includes, for example, a drive ECU that controls the drive system, and an actuator that drives the drive system.

For example, the body-related controller 84 detects and controls a state of a body-related system of the vehicle 50. The body-related system includes, for example, a keyless entry system, a smart key system, a power window apparatus, a power seat, an air conditioner, an air bag, a seat belt, and a shift lever. The body-related controller 84 includes, for example, a body-related ECU that controls the body-related system, and an actuator that drives the body-related system.

For example, the light controller 85 detects and controls states of various lights of the vehicle 50. Examples of a conceivable control-target light include a headlight, a backup light, a fog light, a turn signal, a stoplight, projection, and display of a bumper. The light controller 85 includes, for example, a light ECU that controls the lights, and an actuator that drives the lights.

For example, the horn controller 86 detects and controls a state of a car horn of the vehicle 50. The horn controller 86 includes, for example, a horn ECU that controls the car horn, and an actuator that drives the car horn.

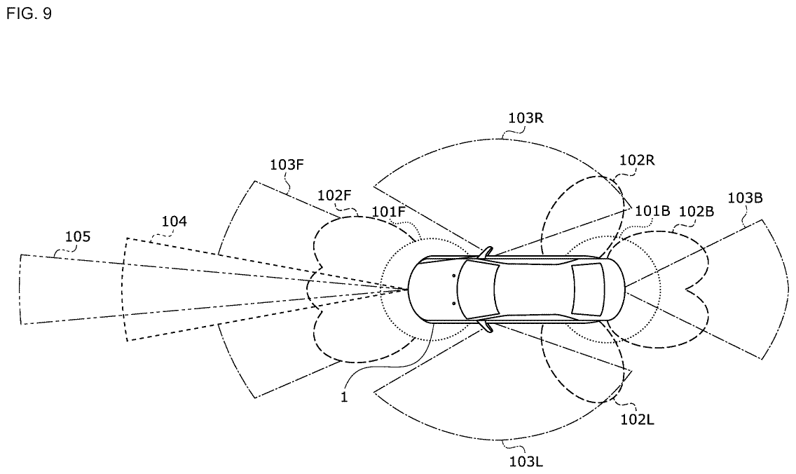

FIG. 9 illustrates an example of regions of sensing performed by, for example, the camera 65, the radar apparatus 66, the LiDAR 67, and the ultrasonic sensor 68 of the external recognition sensor 56 illustrated in FIG. 8. Note that FIG. 9 schematically illustrates the vehicle 50 as viewed from above, where a left-end side in FIG. 9 is a side of a front end (the front) of the vehicle 50, and a right-end side in FIG. 9 is a side of a rear end (the rear) of the vehicle 50.

A sensing region 101F and a sensing region 101B are examples of regions of sensing performed by the ultrasonic sensor 68. The sensing region 101F covers a region around the front end of the vehicle 50 by use of a plurality of ultrasonic sensors 68. The sensing region 101B covers a region around the rear end of the vehicle 50 by use of a plurality of ultrasonic sensors 68.

Results of sensing performed on the sensing region 101F and the sensing region 101B are used to, for example, assist the vehicle 50 in parking.

A region from a sensing region 102F to a sensing region 102B is an example of a region of sensing performed by the radar apparatus 66 used for a short distance and a middle distance. The sensing region 102F covers a region that is situated ahead of the vehicle 50 and farther away from the vehicle 50 than the sensing region 101F. The sensing region 102B covers a region that is situated behind the vehicle 50 and farther away from the vehicle 50 than the sensing region 101B. A sensing region 102L covers a region around a rear portion of a left lateral side of the vehicle 50. A sensing region 102R covers a region around a rear portion of a right lateral side of the vehicle 50.

A result of sensing performed on the sensing region 102F is used to, for example, detect, for example, a vehicle or pedestrian situated ahead of the vehicle 50. A result of sensing performed on the sensing region 102B is used for, for example, a function of preventing collision from occurring behind the vehicle 50. Results of sensing performed on the sensing region 102L and the sensing region 102R are used to, for example, detect an object situated in a region of a blind spot on the lateral side of the vehicle 50.

A region from a sensing region 103F to a sensing region 103B is an example of a region of sensing performed by the camera 65. The sensing region 103F covers a region that is situated ahead of the vehicle 50 and farther away from the vehicle 50 than the sensing region 102F. The sensing region 103B covers a region that is situated behind the vehicle 50 and farther away from the vehicle 50 than the sensing region 102B. A sensing region 103L covers a region around the left lateral side of the vehicle 50. A sensing region 103R covers a region around the right lateral side of the vehicle 50.

A result of sensing performed on the sensing region 103F can be used for, for example, recognition of a traffic light and a traffic sign, a system for assisting in preventing deviation from a lane, and a system for automatically controlling a headlight. A result of sensing performed on the sensing region 103B can be used for, for example, parking assistance and a surround view system. Results of sensing performed on the sensing region 103L and the sensing region 103R can be used for, for example, a surround view system.

A sensing region 104 is an example of a region of sensing performed by the LiDAR 67. The sensing region 104 covers a region that is situated ahead of the vehicle 50 and farther away from the vehicle 50 than the sensing region 103F. On the other hand, the sensing region 104 has a smaller range in the right-and-left direction than the sensing region 103F.

A result of sensing performed on the sensing region 104 is used to detect, for example, an object such as a surrounding vehicle.

A sensing region 105 is an example of a region of sensing performed by the radar apparatus 66 used for a long distance. The sensing region 105 covers a region that is situated ahead of the vehicle 50 and farther away from the vehicle 50 than the sensing region 104. On the other hand, the sensing region 105 has a smaller range in the right-and-left direction than the sensing region 104.

A result of sensing performed on the sensing region 105 is used for, for example, adaptive cruise control (ACC), sudden braking, and collision avoidance.

Note that, in addition to the example illustrated in FIG. 9, various configurations may be adopted for the regions of sensing performed by respective sensors that are the camera 65, the radar apparatus 66, the LiDAR 67, and the ultrasonic sensor 68 of the external recognition sensor 56. Specifically, the ultrasonic sensor 68 may also perform sensing on the lateral side of the vehicle 50, or the LiDAR 67 may perform sensing on a region behind the vehicle 50. Further, positions for placing the respective sensors are not limited to the examples described above. Furthermore, a single sensor or a plurality of sensors may be provided with respect to each of the sensors.

FIG. 10 is a block diagram illustrating an example of a configuration of hardware of the detection processor 20.

The detection processor 20 includes a CPU 201, a ROM 202, a RAM 203, an input/output interface 205, and a bus 204 through which these components are connected to each other. A display section 206, an input section 207, a storage 208, a communication section 209, a drive 210, and the like are connected to the input/output interface 205.

The display section 206 is a display device using, for example, liquid crystal or EL. Examples of the input section 207 include a keyboard, a pointing device, a touch panel, and other operation apparatuses. When the input section 207 includes a touch panel, the touch panel may be integrated with the display section 206.

The storage 208 is a nonvolatile storage device, and examples of the storage 208 include an HDD, a flash memory, and other solid-state memories. The drive 210 is a device that can drive a removable recording medium 211 such as an optical recording medium, a magnetic recording tape, or the like.

The communication section 209 is a modem, a router, or another communication apparatus that can be connected to, for example, a LAN or a WAN and is used to communicate with another device. The communication section 209 may perform communication wirelessly or by wire. The communication section 209 is often used in a state of being separate from the detection processor 20.

Information processing performed by the detection processor 20 having the hardware configuration described above is performed by software stored in, for example, the storage 208 or the ROM 202, and hardware resources of the detection processor 20 working cooperatively. Specifically, the information processing method according to the present technology is performed by loading, into the RAM 203, a program included in the software and stored in the ROM 202 or the like and executing the program.

For example, the program is installed on the detection processor 20 through the recording medium 211. Alternatively, the program may be installed on the detection processor 20 through, for example, a global network. Moreover, any non-transitory computer-readable storage medium may be used.

The information processing method and the program according to the present technology may be executed and the detection processing switcher according to the present technology may be implemented by a certain computer included in a communication terminal and another computer working cooperatively, the other computer being capable of communicating with the certain computer through, for example, a network.

In other words, the information processing system and the information processing apparatus according to the present technology can be operated and the information processing method according to the present technology can be executed not only in a computer system that includes a single computer, but also in a computer system in which a plurality of computers operates cooperatively. Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The operation of the information processing system and the information processing apparatus according to the present technology by the computer system and the execution of the information processing method according to the present technology by the computer system include, for example, both the case in which the calculation of a distance spectrum, the detection of a peak, the switching performed on a detection process, and the like are executed by a single computer; and the case in which the respective processes are executed by different computers. Further, the execution of each process by a specified computer includes causing another computer to execute a portion of or all of the process and acquiring a result of it.

In other words, the information processing system, the information processing apparatus, and the information processing method according to the present technology are also applicable to a configuration of cloud computing in which a single function is shared and cooperatively processed by a plurality of apparatuses through a network.

The respective configurations of the distance distribution calculator, the detection processing switcher, the direction estimation processor, and the like; the flow of controlling a communication system; and the like described with reference to the respective figures are merely embodiments, and any modifications may be made thereto without departing from the spirit of the present technology. In other words, for example, any other configurations or algorithms for purpose of practicing the present technology may be adopted.

Note that the effects described in the present disclosure are not limitative but are merely illustrative, and other effects may be provided. The above-described description of the plurality of effects does not necessarily mean that the plurality of effects is provided at the same time. The above-described description means that at least one of the effects described above is provided depending on, for example, a condition. Of course, there is a possibility that an effect that is not described in the present disclosure will be provided.

At least two of the features of the respective embodiments described above can also be combined. In other words, the various features described in the respective embodiments may be combined discretionarily regardless of the embodiments.

Note that the present technology may also take the following configurations.
(1) An information processing system, including:
   a plurality of radar apparatuses;
   information processing apparatuses that
      each include a distance calculator used to calculate a distance to an object, the calculation of the distance being performed using at least one of the plurality of radar apparatuses, and
      each include a processor that
         causes, when the distance to the object is less than a specified threshold, a process of detecting different reflection points on the object to be performed, the detections of the different reflection points on the object being performed by use of respective radar apparatuses of the plurality of radar apparatuses, and
         causes, when the distance to the object is greater than or equal to the specified threshold, a process of detecting an in-common reflection point on the object to be performed, the detection of the in-common reflection point on the object being performed by digital radar signals from the respective radar apparatuses of the plurality of radar apparatuses being combined; and
   an output apparatus that includes an output section that outputs reflection-point information regarding the reflection point on the basis of the detection processes performed by the processors.
(2) The information processing system according to (1), in which
   the information processing apparatus includes a first estimator that estimates the reflection-point information regarding the different reflection point on the basis of a radar signal related to the object when the distance to the object is less than the specified threshold, and
   the output apparatus includes a second estimator that estimates the reflection-point information regarding the in-common reflection point on the basis of radar signals related to the object when the distance to the object is greater than or equal to the specified threshold.
(3) The information processing system according to (1), in which
   the reflection-point information includes at least one of a distance, a speed, or a direction.
(4) The information processing system according to (1), in which
   the specified threshold includes what is determined on the basis of a positional relationship between the radar apparatuses of the plurality of radar apparatuses arranged.
(5) The information processing system according to (2), in which
   the information processing apparatus includes a switcher that switches between the process of detecting the different reflection points on the object by use of the respective radar apparatuses of the plurality of radar apparatuses, and the process of detecting the in-common reflection point on the object by the digital radar signals from the respective radar apparatuses of the plurality of radar apparatuses being combined, the detections of the different reflection points on the object being performed on the basis of first estimation results respectively obtained by the pieces of reflection-point information being estimated by the respective first estimators, the detection of the in-common reflection point on the object being performed on the basis of a second estimation result obtained by the reflection-point information being estimated by the second estimator.
(6) The information processing system according to (5), in which
   when the second estimation result shows that objects of a plurality of objects are detected at different angles, the switcher switches to the process of detecting the in-common reflection point on the object by the digital radar signals from the respective radar apparatuses of the plurality of radar apparatuses being combined.
(7) The information processing system according to (5), in which
   when the number of the reflection points detected as the second estimation result is larger than the number of the reflection points detected as the first estimation result, the switcher switches to the process of detecting the in-common reflection point on the object by the digital radar signals from the respective radar apparatuses of the plurality of radar apparatuses being combined.
(8) The information processing system according to (5), in which
   when the first estimation result shows that the reflection points are situated close to each other, the switcher switches between the process of detecting the different reflection points on the object by use of the respective radar apparatuses of the plurality of radar apparatuses, and the process of detecting the in-common reflection point on the object by the digital radar signals from the respective radar apparatuses of the plurality of radar apparatuses being combined, the switching being performed on the basis of distances to the respective reflection points and speeds of the respective reflection points.
(9) The information processing system according to (2), in which
   when the distance to the object is less than the specified threshold, the processor outputs the reflection-point information estimated by the first estimator to the output section through a first network, and
   when the distance to the object is greater than or equal to the specified threshold, the processor outputs the radar signal related to the object to the second estimator through a second network.
(10) An information processing apparatus, including:
   a distance calculator used to calculate a distance to an object, the calculation of the distance being performed using at least one of a plurality of radar apparatuses; and
   a processor that
      causes, when the distance to the object is less than a specified threshold, a process of detecting different reflection points on the object to be performed, the detections of the different reflection points on the object being performed by use of respective radar apparatuses of the plurality of radar apparatuses, and
      causes, when the distance to the object is greater than or equal to the specified threshold, a process of detecting an in-common reflection point on the object to be performed, the detection of the in-common reflection point on the object being performed by digital radar signals from the respective radar apparatuses of the plurality of radar apparatuses being combined.
(11) An information processing method that is performed by a computer system, the information processing method including:
   calculating a distance to an object, the calculation of the distance being performed using at least one of a plurality of radar apparatuses;
   when the distance to the object is less than a specified threshold, causing a process of detecting different reflection points on the object to be performed, the detections of the different reflection points on the object being performed by use of respective radar apparatuses of the plurality of radar apparatuses; and
   when the distance to the object is greater than or equal to the specified threshold, causing a process of detecting an in-common reflection point on the object to be performed, the detection of the in-common reflection point on the object being performed by digital radar signals from the respective radar apparatuses of the plurality of radar apparatuses being combined.

### REFERENCE SIGNS LIST

10 plurality of radar apparatuses
20 detection processor
25 detection processing switcher
26 direction estimation processor
40 output apparatus
41 integration detection processor
100 information processing system

1. An information processing system, comprising:
a plurality of radar apparatuses;
information processing apparatuses that
each include a distance calculator used to calculate a distance to an object, the calculation of the distance being performed using at least one of the plurality of radar apparatuses, and
each include a processor that
causes, when the distance to the object is less than a specified threshold, a process of detecting different reflection points on the object to be performed, the detections of the different reflection points on the object being performed by use of respective radar apparatuses of the plurality of radar apparatuses, and
causes, when the distance to the object is greater than or equal to the specified threshold, a process of detecting an in-common reflection point on the object to be performed, the detection of the in-common reflection point on the object being performed by digital radar signals from the respective radar apparatuses of the plurality of radar apparatuses being combined; and
an output apparatus that includes an output section that outputs reflection-point information regarding the reflection point on a basis of the detection processes performed by the processors.

2. The information processing system according to claim 1, wherein
the information processing apparatus includes a first estimator that estimates the reflection-point information regarding the different reflection point on a basis of a radar signal related to the object when the distance to the object is less than the specified threshold, and
the output apparatus includes a second estimator that estimates the reflection-point information regarding the in-common reflection point on a basis of radar signals related to the object when the distance to the object is greater than or equal to the specified threshold.

3. The information processing system according to claim 1, wherein
the reflection-point information includes at least one of a distance, a speed, or a direction.

4. The information processing system according to claim 1, wherein
the specified threshold includes what is determined on a basis of a positional relationship between the radar apparatuses of the plurality of radar apparatuses arranged.

5. The information processing system according to claim 2, wherein
the information processing apparatus includes a switcher that switches between the process of detecting the different reflection points on the object by use of the respective radar apparatuses of the plurality of radar apparatuses, and the process of detecting the in-common reflection point on the object by the digital radar signals from the respective radar apparatuses of the plurality of radar apparatuses being combined, the detections of the different reflection points on the object being performed on a basis of first estimation results respectively obtained by the pieces of reflection-point information being estimated by the respective first estimators, the detection of the in-common reflection point on the object being performed on a basis of a second estimation result obtained by the reflection-point information being estimated by the second estimator.

6. The information processing system according to claim 5, wherein
when the second estimation result shows that objects of a plurality of objects are detected at different angles, the switcher switches to the process of detecting the in-common reflection point on the object by the digital radar signals from the respective radar apparatuses of the plurality of radar apparatuses being combined.

7. The information processing system according to claim 5, wherein
when the number of the reflection points detected as the second estimation result is larger than the number of the reflection points detected as the first estimation result, the switcher switches to the process of detecting the in-common reflection point on the object by the digital radar signals from the respective radar apparatuses of the plurality of radar apparatuses being combined.

8. The information processing system according to claim 5, wherein
when the first estimation result shows that the reflection points are situated close to each other, the switcher switches between the process of detecting the different reflection points on the object by use of the respective radar apparatuses of the plurality of radar apparatuses, and the process of detecting the in-common reflection point on the object by the digital radar signals from the respective radar apparatuses of the plurality of radar apparatuses being combined, the switching being performed on a basis of distances to the respective reflection points and speeds of the respective reflection points.

9. The information processing system according to claim 2, wherein
when the distance to the object is less than the specified threshold, the processor outputs the reflection-point information estimated by the first estimator to the output section through a first network, and
when the distance to the object is greater than or equal to the specified threshold, the processor outputs the radar signal related to the object to the second estimator through a second network.

10. An information processing apparatus, comprising:
a distance calculator used to calculate a distance to an object, the calculation of the distance being performed using at least one of a plurality of radar apparatuses; and
a processor that
causes, when the distance to the object is less than a specified threshold, a process of detecting different reflection points on the object to be performed, the detections of the different reflection points on the object being performed by use of respective radar apparatuses of the plurality of radar apparatuses, and
causes, when the distance to the object is greater than or equal to the specified threshold, a process of detecting an in-common reflection point on the object to be performed, the detection of the in-common reflection point on the object being performed by digital radar signals from the respective radar apparatuses of the plurality of radar apparatuses being combined.

11. An information processing method that is performed by a computer system, the information processing method comprising:
calculating a distance to an object, the calculation of the distance being performed using at least one of a plurality of radar apparatuses;
when the distance to the object is less than a specified threshold, causing a process of detecting different reflection points on the object to be performed, the detections of the different reflection points on the object being performed by use of respective radar apparatuses of the plurality of radar apparatuses; and
when the distance to the object is greater than or equal to the specified threshold, causing a process of detecting an in-common reflection point on the object to be performed, the detection of the in-common reflection point on the object being performed by digital radar signals from the respective radar apparatuses of the plurality of radar apparatuses being combined.
